(19) United States
(12) Patent Application Publication
(10) Pub. No.: US 2024/0054408 A1
(43) Pub. Date: Feb. 15, 2024

(54) AUTOMATIC APPLICATION PROGRAMMING INTERFACE TRIGGERING BASED ON TRAVEL INFORMATION IN A STRUCTURED DATA SET

(71) Applicant: Capital One Services, LLC, McLean, VA (US)

(72) Inventors: Leeyat Bracha TESSLER, Arlington, VA (US); Tyler MAIMAN, Melville, NY (US); Phoebe ATKINS, Rockville, VA (US)

(21) Appl. No.: 17/885,196

(22) Filed: Aug. 10, 2022

(51) Int. Cl. G06Q 10/02; G06F 3/0482; G06F 9/48

(52) U.S. Cl. CPC G06Q 10/02; G06F 3/0482; G06F 9/48

(57) ABSTRACT

In some implementations, a flight system may receive structured data including a plurality of event entries. The flight system may detect, within the structured data, at least one of the plurality of event entries that is associated with a flight. The flight system may transmit, to a first application programming interface (API), a call including an identifier associated with the flight as a parameter. Accordingly, the flight system may receive, from the first API, data associated with the flight that indicates a layover. The flight system may estimate a duration and a location associated with the layover and may generate a set of possible meals based on the duration and the location. The flight system may receive an indication of a selected meal from the set of possible meals. Accordingly, the flight system may trigger a call to a second API to confirm the selected meal.

### BACKGROUND

Generally, a user may reserve a meal during travel from a user device. For example, the user device may include a plurality of mobile application (“apps”) with which the user may interact in order to reserve the meal. For example, the user may reserve the meal during a layover associated with a flight for the user.

### SUMMARY

Some implementations described herein relate to a system for triggering application programming interface (API) calls. The system may include one or more memories and one or more processors communicatively coupled to the one or more memories. The one or more processors may be configured to receive a set of structured data, associated with a user, comprising a plurality of event entries. The one or more processors may be configured to detect, within the set of structured data, at least one event entry, of the plurality of event entries, that is associated with a flight. The one or more processors may be configured to determine that the flight is associated with a layover. The one or more processors may be configured to calculate a duration and a location associated with the layover. The one or more processors may be configured to generate a set of possible meals based on the duration and the location. The one or more processors may be configured to receive, from a user device associated with the user, an indication of a selected meal from the set of possible meals. The one or more processors may be configured to trigger a call to a first API to confirm the selected meal. The one or more processors may be configured to receive, from a second API, an indication of updated scheduling information associated with the flight. The one or more processors may be configured to generate a modification to the selected meal based on the updated scheduling information. The one or more processors may be configured to receive, from the user device, a confirmation of the modification to the selected meal. The one or more processors may be configured to trigger a call to the first API to finalize the modification to the selected meal.

Some implementations described herein relate to a method of triggering API calls. The method may include receiving a set of structured data, associated with a user, comprising a plurality of event entries. The method may include detecting, within the set of structured data, at least one event entry, of the plurality of event entries, that is associated with a flight. The method may include transmitting, to a first API, a call including an identifier associated with the flight as a parameter. The method may include receiving, from the first API, data associated with the flight that indicates a layover. The method may include estimating a duration and a location associated with the layover. The method may include generating a set of possible meals based on the duration and the location. The method may include receiving, from a user device associated with the user, an indication of a selected meal from the set of possible meals. The method may include triggering a call to a second API to confirm the selected meal.

Some implementations described herein relate to a non-transitory computer-readable medium that stores a set of instructions for triggering API calls for a device. The set of instructions, when executed by one or more processors of the device, may cause the device to receive a set of structured data, associated with a user, comprising a plurality of event entries. The set of instructions, when executed by one or more processors of the device, may cause the device to detect, within the set of structured data, at least one event entry, of the plurality of event entries, that is associated with a flight. The set of instructions, when executed by one or more processors of the device, may cause the device to determine that the flight is associated with a layover. The set of instructions, when executed by one or more processors of the device, may cause the device to calculate a duration and a location associated with the layover. The set of instructions, when executed by one or more processors of the device, may cause the device to transmit, to a first API, a call including an identifier of the location as a parameter. The set of instructions, when executed by one or more processors of the device, may cause the device to receive, from the first API, a data structure associated with a map of the location. The set of instructions, when executed by one or more processors of the device, may cause the device to generate a set of possible meals based on the duration and the map. The set of instructions, when executed by one or more processors of the device, may cause the device to receive, from a user device associated with the user, an indication of a selected meal from the set of possible meals. The set of instructions, when executed by one or more processors of the device, may cause the device to trigger a call to a second API to confirm the selected meal.

### BRIEF DESCRIPTION OF THE DRAWINGS

FIGS. 1A-1F are diagrams of an example implementation relating to automatic API triggering based on travel information in a structured data set, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of one or more devices of FIG. 2, in accordance with some embodiments of the present disclosure.

FIG. 4 is a flowchart of an example process relating to automatic API triggering based on travel information in a structured data set, in accordance with some embodiments of the present disclosure.

### DETAILED DESCRIPTION

The following detailed description of example implementations refers to the accompanying drawings. The same reference numbers in different drawings may identify the same or similar elements.

Booking a meal during travel may be performed with multiple application programming interface (API) calls. For example, a user may instruct a user device to perform repeated API calls to select and confirm a meal, out of a plurality of possible meals. Each API call costs processing resources, power, and network resources. Additionally, when the travel changes, the user may again instruct the user device to perform repeated API calls to modify the selected meal.

Some implementations described herein automatically trigger API calls to book a meal based on travel information in a structured data set (e.g., a transaction record). Accordingly, a quantity of API calls used to book the meal is reduced as compared with a user device booking the meal, which conserves processing resources, power, and network resources. Some implementations described herein additionally trigger API calls to modify the meal based on changes to the travel information. Accordingly, a quantity of API calls used to modify the meal is reduced as compared with a user device modifying the meal, which conserves processing resources, power, and network resources.

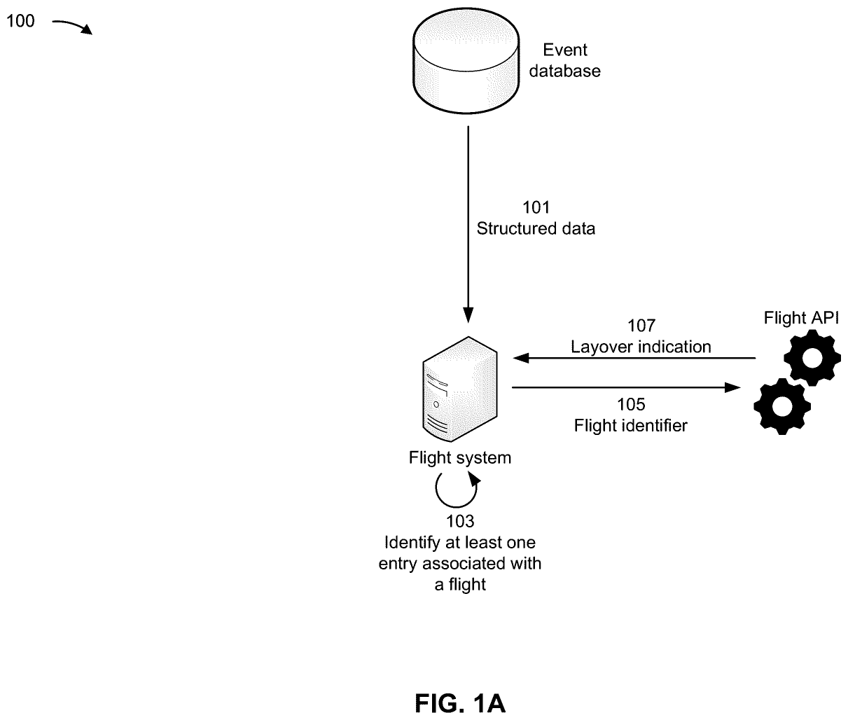

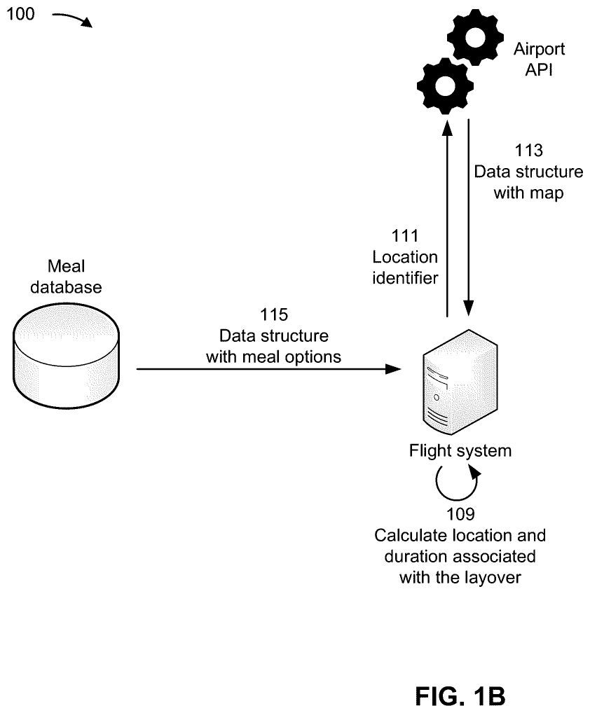

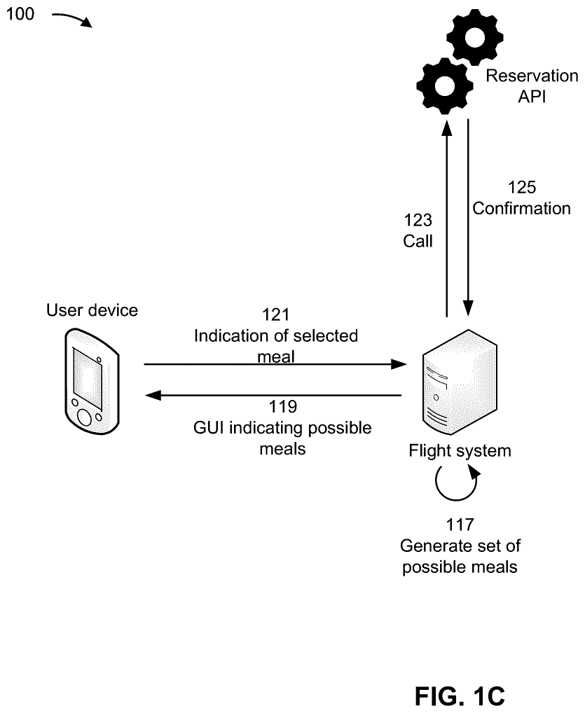

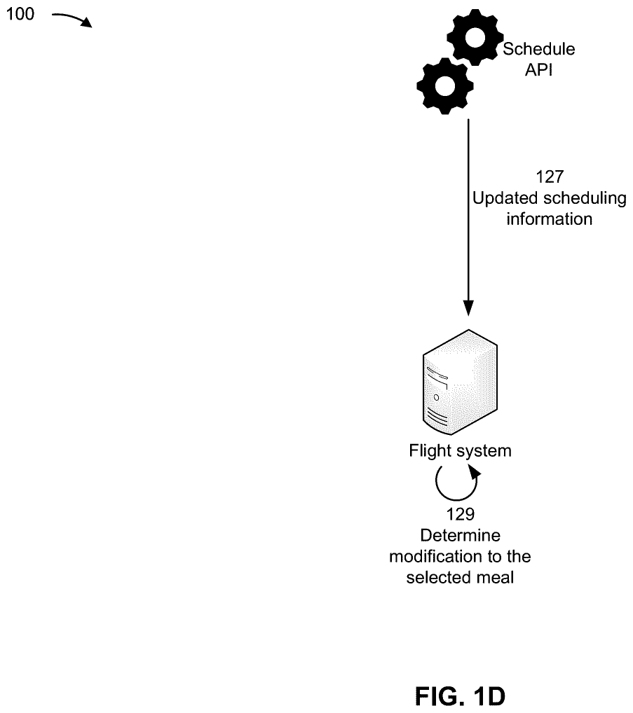

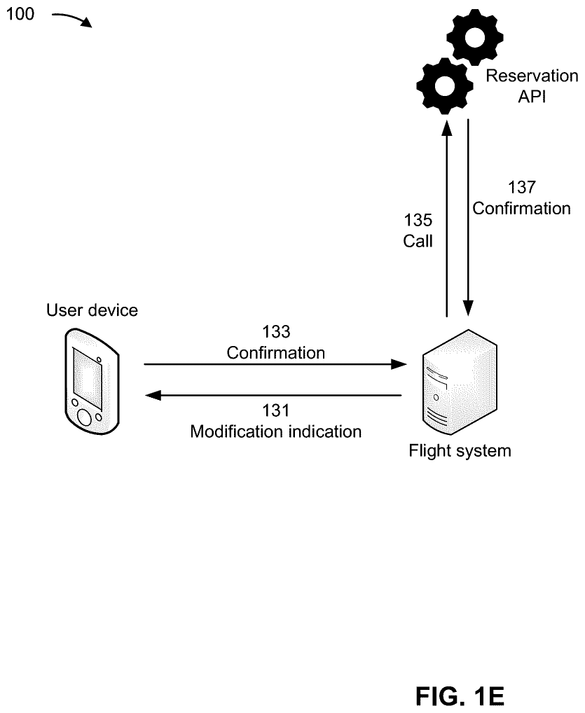

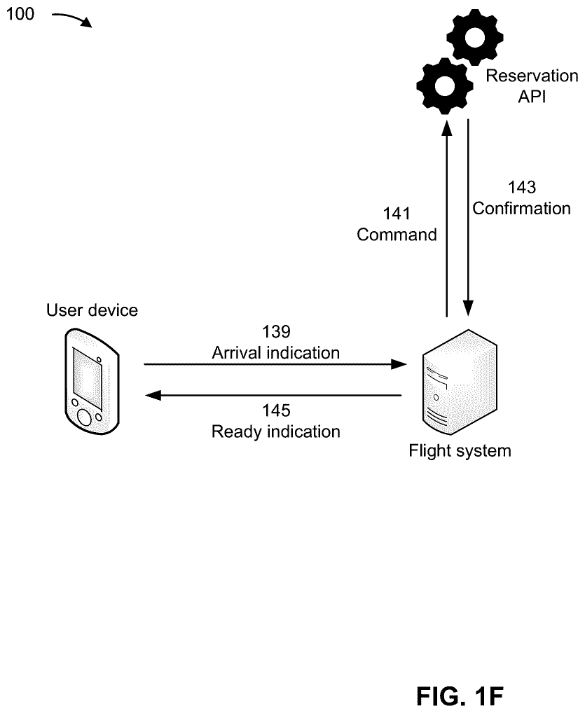

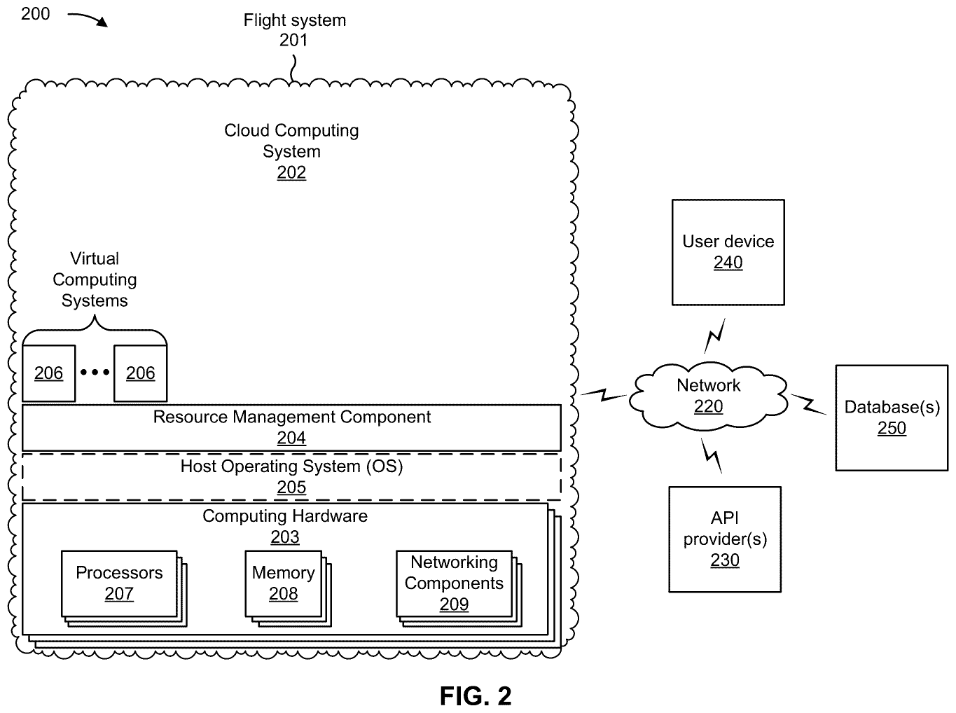

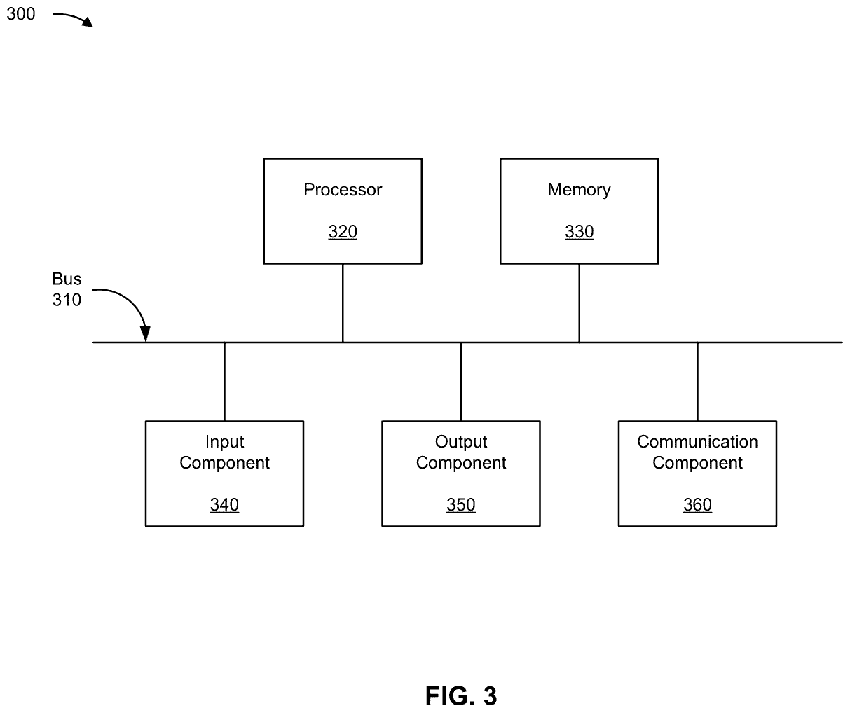

FIGS. 1A-1F are diagrams of an example 100 associated with automatic API triggering based on travel information in a structured data set. As shown in FIGS. 1A-1F, example 100 includes a flight system, an event database, a meal database, a flight API provider, a reservation API provider, a schedule API provider, and a user device. These devices are described in more detail in connection with FIGS. 2 and 3.

As shown in FIG. 1A and by reference number 101, the event database may transmit, and the flight system may receive, a set of structured data associated with a user. For example, the flight system may receive, from the user device, an indicator associated with the user (e.g., a name, a username, or an account number, among other examples) and request the set of structured data from the event database using the indicator. In some implementations, the event database may be secure such that the flight system provides credentials (e.g., one or more credentials, such as a username and password, a personal identification number (PIN), a biometric property, or a certificate, among other examples) with, or prior to, the request. The flight system may also receive the credentials from the user device.

The set of structured data may include event entries (e.g., a plurality of event entries). For example, the set of structured data may be a transaction record associated with the user. Although shown with a single set of structured data, the flight system may receive multiple sets of structured data associated with the user. Additionally, the flight system may request the sets of structured data associated with the user from a plurality of event databases. The event databases may use different user indicators and/or different credentials, such that the user device provides multiple indicators and/or multiple credentials to the flight system.

As shown by reference number 103, the flight system may detect, within the set of structure data, an event entry (e.g., at least one event entry) that is associated with a flight. For example, the flight system may identify, in a description associated with the event entry, a string matching an entry in a database of flight-related strings. For example, the flight system may identify the event entry as being associated with a flight when the description includes “JETBLUE,” “AMERICANAIR,” “KLM,” “QANTAS,” or another similar string. In another example, the flight system may identify the event entry as being associated with a flight when the description includes a pattern matching a flight number pattern (e.g., stored in the database), such as “SWA ####,” “QFA ####,” “KLM ####,” “DAL ####,” or another similar pattern. The database of flight-related strings may be stored locally at the flight system or may be at least partially separate (e.g., logically, physically, and/or virtually) from the flight system.

Although shown as using identification within descriptions associated with the event entries, the flight system may alternatively receive (e.g., from an API associated with flight reservations) an indication of event entry associated with the flight. For example, the flight system may be subscribed to updates from the API (e.g., based on a subscription command received from the user device, optionally with credentials to use for subscribing to the API) such that the API transmits the indication when the flight is reserved by the user. The API may be associated with a travel portal (e.g., a website) that the user is able to access (e.g., via the user device).

Because the flight system automatically identifies the flight after the flight is reserved (e.g., via the indication from the API or via the transaction record), the user device does not perform later, additional API calls to retrieve details about the flight when booking a meal (e.g., as described in connection with FIG. 1C). As a result, processing resources, power, and network resources are conserved.

The flight system may determine that the flight is associated with a layover. For example, as shown by reference number 105, the flight system may transmit, to an API associated with the flight, a call including an identifier associated with the flight as a parameter. Accordingly, as shown by reference number 107, the flight system may receive, from the API associated with the flight, data associated with the flight that indicates the layover. In some implementations, the identifier may include a flight number indication. For example, the flight system may use pattern detection to extract the flight number indication (e.g., as described above). The API may be associated with an airline operating the flight that the flight system is able to access (e.g., via a subscription or another type of authenticated access).

In some implementations, the flight may be associated with a single flight identifier such that the flight identifier is associated with the layover. Accordingly, the API may return the data indicating the layover in response to the flight identifier. For example, the data may indicate a location, a start time, and an end time associated with the layover. In some implementations, the data may further indicate a duration associated with the layover. Additionally, or alternatively, as shown in FIG. 1B and by reference number 109, the flight system may calculate the duration as a difference between the start time and the end time.

Alternatively, the flight may be associated with two flight identifiers such that the flight system makes two calls to the API, one for each flight identifier. Accordingly, as shown by reference number 109, the flight system determines a location associated with the layover as a terminus associated with one of the flight identifiers that is also an origin associated with the other of the flight identifiers. Additionally, as further shown by reference number 109, the flight system may calculate a duration associated with the layover as a difference between an end time associated with one of the flight identifiers (e.g., the flight identifier associated with the location as a terminus) and a start time associated with the other of the flight identifiers (e.g., the flight identifier associated with the location as an origin). The portion of the flight associated with the location as a terminus may be referred to as a “first leg,” and the portion of the flight associated with the location as an origin may be referred to as a “second leg.”

In some implementations, the duration is further based on an amount of time associated with deplaning (e.g., for the first leg) and an amount of time associated with boarding (e.g., for the second leg). For example, the flight system may adjust the duration as indicated in the data from the API based on a single flight identifier or as calculated based on two flight identifiers. In some implementations, the flight system may subtract a preconfigured amount of time associated with deplaning along with a preconfigured amount of time associated with boarding in order to generate an adjusted duration. Alternatively, the flight system may select an amount of time associated with deplaning to apply, from a plurality of possible amounts of time for deplaning, based on an identifier of an airline operating the first leg. For example, the flight system may select the amount of time associated with the airline based on a database mapping airlines to different possible amounts of time for deplaning. The database may be stored locally at the flight system or may be at least partially separate (e.g., logically, physically, and/or virtually) from the flight system. Similarly, the flight system may select an amount of time associated with boarding to apply, from a plurality of possible amounts of time for boarding, based on an identifier of an airline operating the second leg. For example, the flight system may select the amount of time associated with the airline based on a database mapping airlines to different possible amounts of time for boarding. Additionally, in some implementations, the flight system may select the amount of time associated with deplaning and/or the amount of time associated with boarding based on a class of time and/or a boarding order associated with the second leg. The database may be stored locally at the flight system or may be at least partially separate (e.g., logically, physically, and/or virtually) from the flight system.

The location associated with the layover (e.g., as indicated in the data from the API based on a single flight identifier or as determined based on two flight identifiers) may be an airport. In some implementations, the API may further indicate a terminal within the airport associated with the layover. Alternatively, the flight system may determine that the layover is associated with movement from one terminal to another terminal within the airport (e.g., based on data from the API, as described above).

Because the flight system automatically identifies the location and duration associated with the layover after the flight is reserved (e.g., via the indication from the API or via the transaction record), the user device does not perform later, additional API calls to retrieve details about the flight when booking a meal (e.g., as described in connection with FIG. 1C). As a result, processing resources, power, and network resources are conserved.

In some implementations, as shown by reference number 111, the flight system may further transmit, to an API associated with airports, a call including an identifier of the location as a parameter. For example, the identifier may be a name of the airport, a code associated with the airport (e.g., an International Air Transport Association (IATA) airport code), and/or a name of the terminal. The API may be associated with a database of airport maps (e.g., operated by Google® or another data aggregator) or may be associated with the airport itself. Thus, the flight system may select the first API, from a plurality of possible APIs, based on a data structure that links the identifier of the location to an identifier of the API. For example, the flight system may select the API based on a database mapping airport identities to different API identifiers (e.g., Internet protocol (IP) addresses and/or other similar identifiers). The database may be stored locally at the flight system or may be at least partially separate (e.g., logically, physically, and/or virtually) from the flight system.

As shown by reference number 113, the flight system may receive, from the API, a data structure associated with a map of the location. For example, the data structure may be an image (e.g., a joint photographic experts group (JPEG) file, a portable network graphics (PNG) file, or another type of image file), a portable document format (PDF) file, and/or another type of data structure that represents the map of the location (e.g., the airport or at least a portion of the airport including the terminal). Alternatively to the API, the flight system may receive the data structure from a database of maps (e.g., linked to corresponding airport identifiers) and/or by scraping the Internet. For example, the flight system may determine a website to scrape for the data structure based on the airport identifier (e.g., using a database mapping airport identities to different uniform resource locators (URLs)). Additionally, or alternatively, the flight system may periodically scrape the Internet to maintain the database of maps, which may be stored locally at the flight system or may be at least partially separate (e.g., logically, physically, and/or virtually) from the flight system. The flight system may obtain the map in order to reduce a size of a data structure indicating meal options (e.g., as described below), which reduces memory overhead.

The flight system may further receive, from the meal database, a data structure indicating meal options for the user, as shown by reference number 115. The meal database may be stored locally at the flight system or may be at least partially separate (e.g., logically, physically, and/or virtually) from the flight system. In some implementations, the flight system may periodically scrape the Internet to maintain the meal database. For example, the flight system may scrape websites associated with restaurants included in the airport to obtain data structures representing menus for the restaurants. Additionally, or alternatively, the flight system may periodically call APIs (e.g., one or more APIs) associated with restaurants included in the airport (or in the terminal of the airport) to maintain the meal database. For example, the APIs may return data structures representing menus for the restaurants. In some implementations, the flight system may filter the menus based on ratings associated with restaurants and/or meals (e.g., crowdsourced from user devices and/or scraped from the Internet). Accordingly, the flight system may remove (or at least de-prefer) restaurants and/or meals associated with ratings that failed to satisfy a rating threshold.

In some implementations, the flight system may reduce a size of the data structure indicating meal options by only requesting meal options from menus associated with restaurants in the terminal (or terminals) associated with the layover. In some implementations, the flight system may further reduce a size of the data structure indicating meal options by using the map. For example, the flight system may determine locations included on the map (e.g., restaurants) that satisfy a distance threshold from a location associated with the layover (e.g., a gate associated with the first leg and/or a gate associated with the second leg).

Additionally, or alternatively, the flight system may reduce a size of the data structure indicating meal options by only requesting meal options of a certain type. For example, the flight system may only request to-go meal options when the duration associated with the layover fails to satisfy a duration threshold. On the other hand, the flight system may request sit-down meal options (in addition to, or in lieu of, to-go meal options) when the duration associated with the layover satisfies a duration threshold. Although described in connection with two types of meal options, additional meal option types may be used with corresponding thresholds (e.g., a longer sit-down type in contrast to a shorter sit-down type and/or a grab-and-go type in contract to a carry-out type, among other examples).

Additionally, or alternatively, the flight system may reduce a size of the data structure indicating meal options by requesting meal options based on preferences (e.g., one or more preferences) associated with the user. For example, the user device may transmit, and the flight system may receive, indications of the preferences. The preferences may include a hard constraint (e.g., an allergy requirement such that any meal option not satisfying the allergy requirement is not requested or a spice preference such that any meal option that is too spicy is not requested, among other examples) and/or a soft constraint (e.g., a flavor preference such that meal options not satisfying the flavor preferences are only requested if a quantity of meal options would otherwise fail to satisfy a quantity threshold).

Additionally, or alternatively, the flight system may reduce a size of the data structure indicating meal options by requesting meal options based on a meal service (if any) associated with the second leg. For example, when the second leg is associated with meal service, the flight system may only request smaller meal options (e.g., carry-out meal options, to-go meal options, or grab-and-go meal options, among other examples). On the other hand, when the second leg is not associated with meal service, the flight system may request larger meal options (in addition to, or in lieu of, the smaller meal options). Additionally, or alternatively, the flight system may apply a soft constraint (e.g., as described above) based on possible flavors for the meal service associated with the second leg.

Additionally, or alternatively, the flight system may reduce a size of the data structure indicating meal options by requesting meal options based on a type of trip and/or the destination associated with the flight. For example, the user device may transmit, and the flight system may receive, an indication of the type of trip (e.g., business, leisure, family vacation, or couples getaway, among other examples). Accordingly, the flight system may select meal options based on the type of trip. For example, the flight system may select larger, sit-down meals for a couples getaway but select quicker, carry-out options for a family vacation. Additionally, or alternatively, the flight system may select more expensive meals for a leisure trip and less expensive meals for a business trip. The flight system may additionally, or alternatively, select meals corresponding to the destination. For example, the flight system may select Mexican food for a trip to Cancun or select pasta for a trip to Rome, among other examples. In some implementations, the flight system may select meals corresponding to the destination for leisure trips but not for business trips.

Accordingly, the data structure indicating meal options for the user may include at least a portion of menus (e.g., one or more menus) associated with restaurants in the airports. In some implementations, the flight system may further selecting a subset, from a set of meals indicated in the data structure, as a set of possible meals. A “possible meal” refers to a meal that is available during a time associated with the layover. Additionally, in some implementations, a “possible meal” refers to a meal that is available within a distance of a gate, associated with the layover, that satisfies a distance threshold. A “possible meal” may be a meal that further satisfies constraints (e.g., one or more constraints), as described below.

In some implementations, the flight system may apply constraints to the set of meals based on the location, the duration, preferences, and/or meal service associated with the second leg, as described above. Accordingly, the flight system may apply constraints to reduce the size of the data structure before received (e.g., to conserve network resources) and/or to reduce a size of the set of possible meals after the data structure is received (e.g., to reduce memory allocation before contacting the user device, as described in connection with reference number 119).

As shown in FIG. 1C and by reference number 119, the flight system may transmit, and the user device may receive, instructions to generate a graphical user interface (GUI) indicating the set of possible meals. For example, the instructions may be associated with a push notification or with components (e.g., one or more components) of the GUI associated with a mobile application executed, or website displayed, on the user device. Alternatively, the instructions may be associated with an email, text message, and/or another type of communication transmitted to the user device.

Accordingly, as shown by reference number 121, the user device may transmit, and the flight system may receive, an indication of a selected meal from the set of possible meals. For example, the indication may be based on interaction with the GUI (e.g., the user clicking or tapping a button).

Based on the indication, the flight system may trigger a call to an API, associated with the restaurant offering the selected meal, to confirm the selected meal, as shown by reference number 123. The flight system may select the API, from a plurality of possible APIs, based on a data structure that links the identifier of the selected meal to an identifier of the API. For example, the flight system may select the API based on a database mapping restaurant identifiers (associated with different menus) to different API identifiers (e.g., IP addresses and/or other similar identifiers). The database may be stored locally at the flight system or may be at least partially separate (e.g., logically, physically, and/or virtually) from the flight system.

In some implementations, the API may return a confirmation to the flight system, as shown by reference number 125. Accordingly, the flight system may transmit, and the user device may receive, the confirmation. For example, the confirmation may include an alphanumeric indicator of a reservation or an alphanumeric indicator of an order, among other examples.

In some implementations, a schedule associated with the flight (e.g., with the first leg and/or with the second leg) may change. Accordingly, as shown in FIG. 1D and by reference number 127, the flight system may receive, from an API associated with flight scheduling, an indication updated scheduling information associated with the flight. For example, the flight system may be subscribed to updates from the API (e.g., based on a subscription) such that the API transmits the updated scheduling information when the change is detected. The API may be associated with a schedule aggregator (e.g., FlightAware®) that the flight system is able to access (e.g., via a subscription).

Because the flight system automatically identifies the updated scheduling information (e.g., via the indication from the API), the user device does not perform later, additional API calls to retrieve updates about the flight when modifying the meal (e.g., as described in connection with FIG. 1E). As a result, processing resources, power, and network resources are conserved.

As shown by reference number 129, the flight system may determine a modification to the selected meal. For example, the flight system may generate the modification based on the updated scheduling information. In some implementations, the flight system may reduce a size of the selected meal when the duration associated with the layover decreases (e.g., and the decrease satisfies a reduction threshold). Similarly, the flight system may cancel the selected meal and propose a new selected meal when the duration associated with the layover decreases (e.g., and the decrease satisfies a cancellation threshold). Alternatively, the flight system may increase a size of the selected meal when the duration associated with the layover increases (e.g., and the increase satisfies an addition threshold). Similarly, the flight system may cancel the selected meal and propose a new selected meal when the duration associated with the layover increases (e.g., and the increase satisfies a cancellation threshold). Additionally, or alternatively, the flight system may cancel the selected meal and propose a new selected meal when the location associated with the layover changes (e.g., a different gate for the first leg and/or the second leg or a different terminal for the first leg and/or the second leg, among other examples).

In some implementations, the flight system may propose the new selected meal from the previously used set of possible meals (e.g., cached from the original booking). However, if the change in duration satisfies a significance threshold (and/or a distance between an old location and a new location satisfies a significance threshold), the flight system may determine a new set of possible meals (e.g., as described in connection with FIG. 1B) such that the flight system proposes the new selected meal from the new set of possible meals.

Accordingly, as shown in FIG. 1E and by reference number 131, the flight system may transmit, and the user device may receive, instructions to generate a GUI indicating the new selected meal (or a new set of possible meals). For example, the instructions may be associated with a push notification or with components (e.g., one or more components) of the GUI associated with a mobile application executed, or website displayed, on the user device. Alternatively, the instructions may be associated with an email, text message, and/or another type of communication transmitted to the user device.

Accordingly, as shown by reference number 133, the user device may transmit, and the flight system may receive, a confirmation of the new selected meal (or an indication of the new selected meal from the new set of possible meals). For example, the confirmation may be based on interaction with the GUI (e.g., the user clicking or tapping a button).

Based on the confirmation, the flight system may trigger a call to an API, associated with the restaurant offering the new selected meal, to confirm the new selected meal, as shown by reference number 135. The flight system may select the API, from a plurality of possible APIs, based on a data structure that links the identifier of the new selected meal to an identifier of the API. For example, the flight system may select the API based on the database mapping restaurant identifiers (associated with different menus) to different API identifiers (e.g., IP addresses and/or other similar identifiers).

In some implementations, the API may return a confirmation to the flight system, as shown by reference number 137. Accordingly, the flight system may transmit, and the user device may receive, the confirmation. For example, the confirmation may include an alphanumeric indicator of a reservation or an alphanumeric indicator of an order, among other examples. Although described in connection with the new selected meal, similar operations may be performed for a modification to the selected meal, as described above. For example, the flight system may trigger the call to the API to finalize the modification to the selected meal.

In some implementations, as shown in FIG. 1F and by reference number 139, the user device may transmit, and the flight system may receive, an indication that the user has arrived for the layover. For example, the user device may transmit the indication based on a global navigation satellite system (GNSS) location associated with the user device. Alternatively, the flight system may receive, from the API associated with flight scheduling, an indication that the user has arrived for the layover. For example, the flight system may be subscribed to updates from the API (e.g., based on a subscription) such that the API transmits the indication when the first leg has landed and/or arrived at a gate. The API may be associated with a schedule aggregator (e.g., FlightAware®) that the flight system is able to access (e.g., via a subscription).

Accordingly, based on the user having arrived, the flight system may transmit, to the API associated with the restaurant offering the selected meal, a command to initiate the selected meal, as shown by reference number 141. Further, as shown by reference umber 143, the flight system may receive, from the API, a confirmation when the selected meal is ready. Accordingly, as shown by reference number 145, the flight system may transmit, and the user device may receive, an indication that the selected meal is ready. For example, the indication may be associated with a push notification or with components (e.g., one or more components) of a GUI associated with a mobile application executed, or website displayed, on the user device. Alternatively, the indication may be associated with an email, text message, and/or another type of communication transmitted to the user device.

In some implementations, the flight system may transmit, and the user device may receive, directions associated with the map to a location associated with the selected meal. For example, the flight system may instruct the user how to proceed to the restaurant offering the selected meal after transmitting to the command to the API. In some implementations, the directions may include a hyperlink to a third-party service offering airport wayfinding (e.g., Google®).

Because the flight system automatically determines when the user has arrived (e.g., via the indication from the user device and/or the API), the user device does not perform later, additional API calls to initiate the selected meal. As a result, processing resources, power, and network resources are conserved.

As indicated above, FIGS. 1A-1F are provided as an example. Other examples may differ from what is described with regard to FIGS. 1A-1F.

FIG. 2 is a diagram of an example environment 200 in which systems and/or methods described herein may be implemented. As shown in FIG. 2, environment 200 may include a flight system 201, which may include one or more elements of and/or may execute within a cloud computing system 202. The cloud computing system 202 may include one or more elements 203-209, as described in more detail below. As further shown in FIG. 2, environment 200 may include a network 220, one or more API providers 230, a user device 240, and/or one or more databases 250. Devices and/or elements of environment 200 may interconnect via wired connections and/or wireless connections.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

Computing hardware 203 includes hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 includes a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines. Additionally, or alternatively, the resource management component 204 may include a container manager, such as when the virtual computing systems 206 are containers. In some implementations, the resource management component 204 executes within and/or in coordination with a host operating system 205.

A virtual computing system 206 includes a virtual environment that enables cloud-based execution of operations and/or processes described herein using computing hardware 203. As shown, a virtual computing system 206 may include a virtual machine, a container, or a hybrid environment that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the flight system 201 may include one or more elements 203-209 of the cloud computing system 202, may execute within the cloud computing system 202, and/or may be hosted within the cloud computing system 202, in some implementations, the flight system 201 may not be cloud-based (e.g., may be implemented outside of a cloud computing system) or may be partially cloud-based. For example, the flight system 201 may include one or more devices that are not part of the cloud computing system 202, such as device 300 of FIG. 3, which may include a standalone server or another type of computing device. The flight system 201 may perform one or more operations and/or processes described in more detail elsewhere herein.

Network 220 includes one or more wired and/or wireless networks. For example, network 220 may include a cellular network, a public land mobile network (PLMN), a local area network (LAN), a wide area network (WAN), a private network, the Internet, and/or a combination of these or other types of networks. The network 220 enables communication among the devices of environment 200.

The API provider(s) 230 may include one or more devices capable of receiving, generating, storing, processing, providing, and/or routing information associated with flights, airports, and/or meals, as described elsewhere herein. The API provider(s) 230 may include a communication device and/or a computing device. For example, the API provider(s) 230 may include a server, such as an application server, a client server, a web server, a database server, a host server, a proxy server, a virtual server (e.g., executing on computing hardware), or a server in a cloud computing system. In some implementations, the API provider(s) 230 may include computing hardware used in a cloud computing environment.

The user device 240 may include one or more devices capable of receiving, generating, storing, processing, and/or providing information associated with reserving flights and/or meals, as described elsewhere herein. The user device 240 may include a communication device and/or a computing device. For example, the user device 240 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The database(s) 250 may be implemented on one or more devices capable of receiving, generating, storing, processing, and/or providing information associated with flights, airports, and/or meals, as described elsewhere herein. The database(s) 250 may be implemented on communication devices and/or computing devices. For example, the database(s) 250 may be implemented on servers, database servers, application servers, client servers, web servers, host servers, proxy servers, virtual servers (e.g., executing on computing hardware), servers in a cloud computing system, devices that includes computing hardware used in a cloud computing environment, or similar types of devices.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with automatic API triggering based on travel information in a structured data set. Device 300 may correspond to API provider(s) 230, user device 240, and/or device(s) implementing database(s) 250. In some implementations, the API provider(s) 230, the user device 240, and/or device(s) implementing the database(s) 250 may include one or more devices 300 and/or one or more components of device 300. As shown in FIG. 3, device 300 may include a bus 310, a processor 320, a memory 330, an input component 340, an output component 350, and a communication component 360.

Bus 310 may include one or more components that enable wired and/or wireless communication among the components of device 300. Bus 310 may couple together two or more components of FIG. 3, such as via operative coupling, communicative coupling, electronic coupling, and/or electric coupling. Processor 320 may include a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 may include one or more processors capable of being programmed to perform one or more operations or processes described elsewhere herein.

Memory 330 may include volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 may include one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

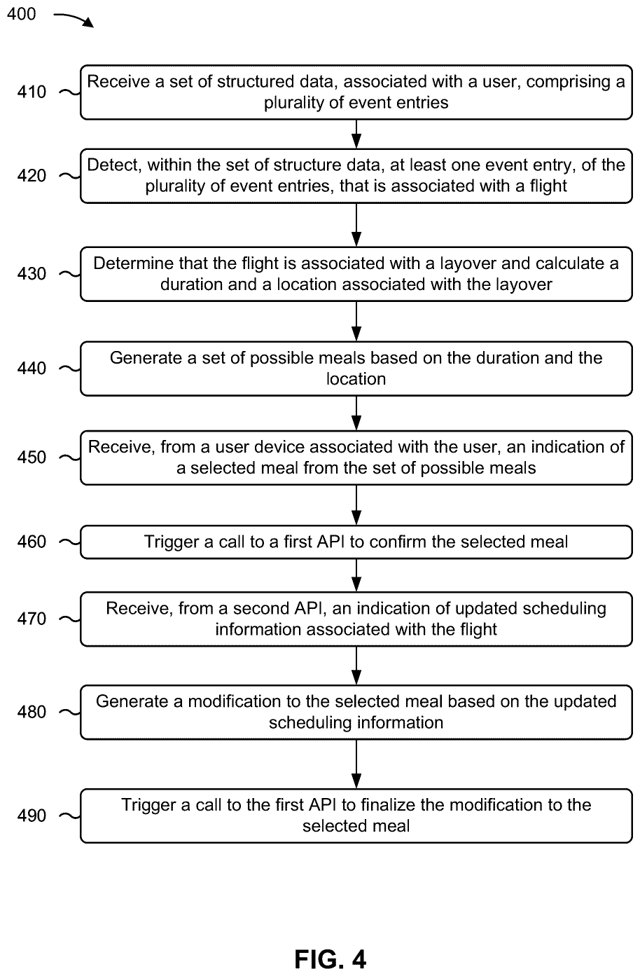

FIG. 4 is a flowchart of an example process 400 associated with automatic API triggering based on travel information in a structured data set. In some implementations, one or more process blocks of FIG. 4 may be performed by the flight system 201. In some implementations, one or more process blocks of FIG. 4 may be performed by another device or a group of devices separate from or including the flight system 201, such as API provider(s) 230, user device 240, and/or device(s) implementing database(s) 250. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving a set of structured data, associated with a user, comprising a plurality of event entries (block 410). For example, the flight system 201 (e.g., using processor 320, memory 330, input component 340, and/or communication component 360) may receive a set of structured data, associated with a user, comprising a plurality of event entries, as described above in connection with reference number 101 of FIG. 1A. As an example, the set of structured data may be a transaction record associated with the user. The user may provide (e.g., via a user device) credentials such that the flight system obtains the set of structured data using the credentials.

As further shown in FIG. 4, process 400 may include detecting, within the set of structured data, at least one event entry, of the plurality of event entries, that is associated with a flight (block 420). For example, the flight system 201 (e.g., using processor 320 and/or memory 330) may detect, within the set of structured data, at least one event entry, of the plurality of event entries, that is associated with a flight, as described above in connection with reference number 103 of FIG. 1A. As an example, the flight system may identify the at least one event entry as being associated with the flight when a description, associated with the at least one event entry, includes a string matching an entry in a database of flight-related strings. In another example, the flight system may identify the at least one event entry as being associated with the flight when the description includes a pattern matching a flight number pattern (e.g., stored in a database of flight-related patterns).

As further shown in FIG. 4, process 400 may include determining that the flight is associated with a layover and calculating a duration and a location associated with the layover (block 430). For example, the flight system 201 (e.g., using processor 320 and/or memory 330) may determine that the flight is associated with a layover, as described above in connection with reference number 107 of FIG. 1A, and calculate a duration and a location associated with the layover, as described above in connection with reference number 109 of FIG. 1B. As an example, the flight system may transmit, to an API associated with the flight, a call including one or more identifiers associated with the flight as a parameter. Accordingly, the flight system may receive, from the API associated with the flight, data associated with the flight that indicates the layover. In some implementations, the data associated with the flight may indicate the duration and/or the location. Additionally, or alternatively, the flight system may determine a location associated with the layover as a terminus associated with a first leg of the flight that is also an origin associated with the second leg of the flight. Similarly, the flight system may calculate a duration associated with the layover as a difference between an end time associated with the first leg of the flight and a start time associated with the second leg of the flight.

As further shown in FIG. 4, process 400 may include generating a set of possible meals based on the duration and the location (block 440). For example, the flight system 201 (e.g., using processor 320 and/or memory 330) may generate a set of possible meals based on the duration and the location, as described above in connection with reference number 117 of FIG. 1C. As an example, the flight system may apply constraints, as described in connection with FIG. 1B, to determine the set of possible meals from a meal database and/or as a subset of a larger set of meals.

As further shown in FIG. 4, process 400 may include receiving, from a user device associated with the user, an indication of a selected meal from the set of possible meals (block 450). For example, the flight system 201 (e.g., using processor 320, memory 330, input component 340, and/or communication component 360) may receive, from a user device associated with the user, an indication of a selected meal from the set of possible meals, as described above in connection with reference number 121 of FIG. 1C. As an example, the indication may be based on interaction with a GUI (e.g., the user clicking or tapping a button).

As further shown in FIG. 4, process 400 may include triggering a call to a first API to confirm the selected meal (block 460). For example, the flight system 201 (e.g., using processor 320 and/or memory 330) may trigger a call to a first API to confirm the selected meal, as described above in connection with reference number 123 of FIG. 1C. As an example, the flight system may select the first API, from a plurality of possible first APIs, based on a data structure that links the identifier of the selected meal to an identifier of the first API. For example, the flight system may select the first API based on a database mapping restaurant identifiers (associated with different menus) to different API identifiers (e.g., IP addresses and/or other similar identifiers).

As further shown in FIG. 4, process 400 may include receiving, from a second API, an indication of updated scheduling information associated with the flight (block 470). For example, the flight system 201 (e.g., using processor 320, memory 330, input component 340, and/or communication component 360) may receive, from a second API, an indication of updated scheduling information associated with the flight, as described above in connection with reference number 127 of FIG. 1D. As an example, the flight system may be subscribed to updates from the second API (e.g., based on a subscription) such that the second API transmits the updated scheduling information when a change for the flight is detected. The second API may be associated with a schedule aggregator (e.g., FlightAware®) that the flight system is able to access (e.g., via a subscription).

As further shown in FIG. 4, process 400 may include generating a modification to the selected meal based on the updated scheduling information (block 480). For example, the flight system 201 (e.g., using processor 320 and/or memory 330) may generate a modification to the selected meal based on the updated scheduling information, as described above in connection with reference number 129 of FIG. 1D. As an example, the flight system may change a size of the selected meal when the duration associated with the layover changes or may cancel the selected meal and propose a new selected meal when the duration and/or the location associated with the layover changes.

As further shown in FIG. 4, process 400 may include triggering a call to the first API to finalize the modification to the selected meal (block 490). For example, the flight system 201 (e.g., using processor 320 and/or memory 330) may trigger a call to the first API to finalize the modification to the selected meal, as described above in connection with reference number 135 of FIG. 1E.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1F. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for triggering application programming interface (API) calls, the system comprising:
one or more memories; and
one or more processors, communicatively coupled to the one or more memories, configured to:
receive a set of structured data, associated with a user, comprising a plurality of event entries;
detect, within the set of structured data, at least one event entry, of the plurality of event entries, that is associated with a flight;
determine that the flight is associated with a layover;
calculate a duration and a location associated with the layover;
transmit, to a first API, a call including an identifier of the location as a parameter;
receive, from the first API, a data structure associated with a map of the location;
generate a set of possible meals based on the map;
receive, from a user device associated with the user, an indication of a selected meal from the set of possible meals;
trigger a call to a second API to confirm the selected meal;
receive, from a third API, an indication of updated scheduling information associated with the flight;
generate a modification to the selected meal based on the updated scheduling information;
receive, from the user device, a confirmation of the modification to the selected meal; and
trigger a call to the second API to finalize the modification to the selected meal.

2. The system of claim 1, wherein the one or more processors are further configured to:
transmit, to the user device, instructions to generate a graphical user interface (GUI) indicating the set of possible meals, wherein the indication of the selected meal is received based on interaction with the GUI.

3. The system of claim 1, wherein the one or more processors, to determine that the flight is associated with a layover, are configured to:
transmit, to a fourth API, a call including an identifier associated with the flight as a parameter; and
receive, from the fourth API, data associated with the flight that indicates the layover.

4. The system of claim 3, wherein the data indicates the location, a start time associated with the layover, and an end time associated with the layover.

5. The system of claim 1, wherein the one or more processors, to generate the set of possible meals, are configured to:
identify one or more menus associated with the location; and
generate the set of possible meals, from the one or more menus, based on the duration.

6. The system of claim 5, wherein the set of possible meals is further based on one or more preferences associated with the user.

7. The system of claim 5, wherein the one or more processors, to identify the one or more menus, are configured to:
transmit, to a fourth API, a call including an indication of the location; and
receive, from the fourth API, a data structure including at least a portion of the one or more menus.

8. A method of triggering application programming interface (API) calls, comprising:
receiving a set of structured data, associated with a user, comprising a plurality of event entries;
detecting, within the set of structured data, at least one event entry, of the plurality of event entries, that is associated with a flight;
transmitting, to a first API, a call including an identifier associated with the flight as a parameter;
receiving, from the first API, data associated with the flight that indicates a layover;
estimating a duration and a location associated with the layover;
transmitting, to a second API, a call including an identifier of the location as a parameter;
receiving, from the second API, a data structure associated with a map of the location;
generating a set of possible meals based on the duration and the map;
receiving, from a user device associated with the user, an indication of a selected meal from the set of possible meals; and
triggering a call to a third API to confirm the selected meal.

9. The method of claim 8, wherein detecting the at least one event entry associated with the flight comprises:
identifying, in a description associated with the at least one event entry, a string matching an entry in a database of flight-related strings.

10. The method of claim 8, wherein detecting the at least one event entry associated with the flight comprises:
receiving, from a fourth API, an indication of the at least one event entry associated with the flight.

11. The method of claim 8, further comprising:
transmitting, to a fourth API, a call including an identifier associated with the flight as a parameter; and
receiving, from the fourth API, data indicating the location, wherein the location is a terminal within an airport.

12. The method of claim 8, wherein generating the set of possible meals comprises:
determining, based on one or more menus associated with the location, a set of meals; and
selecting a subset, from the set of meals, as the set of possible meals by applying one or more constraints based on the duration.

13. The method of claim 8, further comprising:
selecting the third API, from a plurality of possible APIs, based on a data structure that links the selected meal to an identifier of the third API.

14. The method of claim 8, further comprising:
receiving an indication that the user has arrived for the layover;
transmitting, to the third API, a command to initiate the selected meal;
receiving, from the third API, a confirmation when the selected meal is ready; and
transmitting, to the user device, an indication that the selected meal is ready.

15. A non-transitory computer-readable medium storing a set of instructions for triggering application programming interface (API) calls, the set of instructions comprising:
one or more instructions that, when executed by one or more processors of a device, cause the device to:
receive a set of structured data, associated with a user, comprising a plurality of event entries;
detect, within the set of structured data, at least one event entry, of the plurality of event entries, that is associated with a flight;
determine that the flight is associated with a layover;
calculate a duration and a location associated with the layover;
transmit, to a first API, a call including an identifier of the location as a parameter;
receive, from the first API, a data structure associated with a map of the location;
generate a set of possible meals based on the duration and the map;
receive, from a user device associated with the user, an indication of a selected meal from the set of possible meals; and
trigger a call to a second API to confirm the selected meal.

16. The non-transitory computer-readable medium of claim 15, wherein the one or more instructions, when executed by the one or more processors, further cause the device to:
transmit, to the user device, directions associated with the map to a location associated with the selected meal.

17. The non-transitory computer-readable medium of claim 15, wherein the one or more instructions, that cause the device to generate the set of possible meals, cause the device to:
determine a distance threshold based on the duration; and
select the set of possible meals based on locations included on the map that satisfy the distance threshold from a location associated with the layover.

18. The non-transitory computer-readable medium of claim 15, wherein the one or more instructions, that cause the device to calculate the duration, cause the device to:
receive an end time associated with a first leg of the flight;
receive a start time associated with a second leg of the flight; and
calculate the duration based on the end time and the start time.

19. The non-transitory computer-readable medium of claim 18, wherein the duration is further based on an amount of time associated with deplaning and an amount of time associated with boarding.

20. The non-transitory computer-readable medium of claim 15, wherein the one or more instructions, when executed by the one or more processors, further cause the device to:
select the first API, from a plurality of possible APIs, based on a data structure that links the identifier of the location to an identifier of the first API.
